(19) United States
(12) Patent Application Publication
(10) Pub. No.: US 2026/0359063 A1
(43) Pub. Date: Nov. 12, 2026

(54) ELECTRONIC APPARATUS

(71) Applicant: KYOCERA Document Solutions Inc., Osaka (JP)

(72) Inventors: Tomoki Isono, Osaka (JP); Haruo Ito, Osaka (JP); Kuniaki Oyama, Osaka (JP); Ryuichi Okumura, Osaka (JP); Koji Kuroda, Osaka (JP)

(21) Appl. No.: 19/311,706

(22) Filed: Aug. 27, 2025

(30) Foreign Application Priority Data
Sep. 3, 2024 (JP) 2024-151654

(51) Int. Cl. G06F 9/4401

(52) U.S. Cl. CPC G06F 9/4401

(57) ABSTRACT

A processor is configured to execute a program of a predetermined control system. A boot sequencer is configured to perform a boot process of the control system using the processor. A debug circuit is configured to collect debug information of the control system. Further, if the processor can operate when a debug request is detected, the processor starts power supply and clock supply to the debug circuit, and the debug circuit performs collection of the debug information. Contrarily, if the processor can not operate when a debug request is detected, the boot sequencer (a) reboots the control system after saving debug information to a nonvolatile memory, and (b) after rebooting, starts power supply and clock supply to the debug circuit and restores the debug information, and the debug circuit performs collection of the debug information after restoring the debug information.

### CROSS-REFERENCE TO RELATED APPLICATIONS

This application relates to and claims priority rights from Japanese Patent Application No. 2024-151654, filed on Sep. 3rd, 2024, the entire disclosures of which are hereby incorporated by reference herein.

### BACKGROUND

### 1. Field of the Present Disclosure

The present disclosure relates to an electronic apparatus.

### 2. Description of the Related Art

An electronic apparatus has a normal operation mode and a debug mode as operation modes; and if an abnormal operation is detected in an initial operation when powered on or in an operation after it, the electronic apparatus moves to the debug mode, and starts power supply to a debug circuit and thereby enables debugging.

However, if a control system in the electronic apparatus can not operate due to the abnormal operation or the like, the electronic apparatus may not immediately move to the debug mode and may not perform effective debugging.

### SUMMARY

An electronic apparatus according to an aspect of the present disclosure includes a processor, a boot sequencer, a debug circuit, and a nonvolatile memory. The processor is configured to execute a program of a predetermined control system. The boot sequencer is configured to perform a boot process of the control system using the processor. The debug circuit is configured to collect debug information of the control system. Further, if the processor can operate when a debug request is detected, the processor starts power supply and clock supply to the debug circuit, and the debug circuit performs collection of the debug information. Contrarily, if the processor can not operate when a debug request is detected, the boot sequencer (a) reboots the control system after saving debug information to the nonvolatile memory, and (b) after rebooting, starts power supply and clock supply to the debug circuit and restores the debug information, and the debug circuit performs collection of the debug information after restoring the debug information.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an electronic apparatus according to an embodiment of the present disclosure; and

FIG. 2 shows a flowchart that explains a behavior of the electronic apparatus shown in FIG. 1.

### DETAILED DESCRIPTION

Hereinafter, an embodiment according to an aspect of the present disclosure will be explained with reference to drawings.

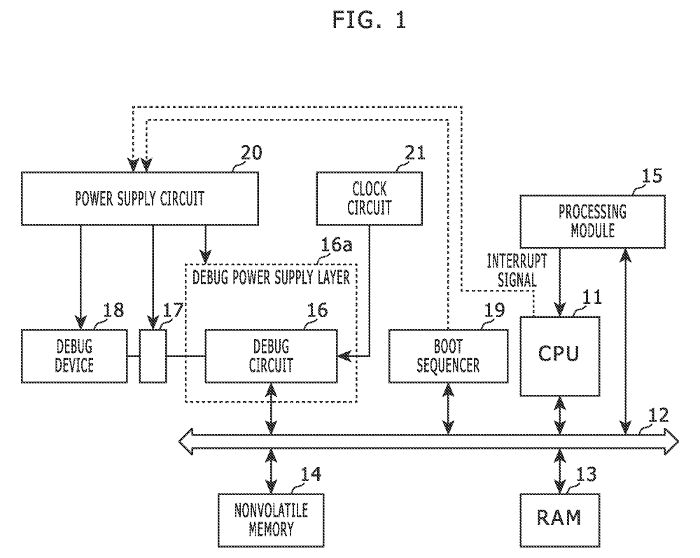

FIG. 1 shows a block diagram that indicates a configuration of an electronic apparatus according to an embodiment of the present disclosure. The electronic apparatus shown in FIG. 1 includes a CPU (Central Processing Unit) 11 as a processor, a signal line 12 such as a system bus, a RAM (Random Access Memory) 13, a nonvolatile memory 14 such as a flash memory or an EEPROM (Electrically Erasable Programmable Read Only Memory), and a processing module 15. For example, the CPU 11, the signal line 12, the RAM 13, the nonvolatile memory 14, and the processing module 15 are installed as a single or plural semiconductor integrated circuits.

The CPU 11 executes a program of a predetermined control system, performs a process described in the program, and thereby performs control of the processing module 15 or the like. The CPU 11, the RAM 13, the nonvolatile memory 14, and the processing module 15 are connected to the signal line 12, and the CPU 11 and the processing module 15 are capable of data communication with each other through the signal line 12 and capable of data read and data write of the RAM 13 and the nonvolatile memory 14.

The processing module 15 is a hardware module that has a predetermined function, and performs a predetermined process in accordance with an instruction from the CPU 11 and outputs an interrupt signal to the CPU 11 when required.

Further, the electronic apparatus shown in FIG. 1 further includes a debug circuit 16, a debug interface 17, a debug device 18, a boot sequencer 19, a power supply circuit 20, and a clock circuit 21.

The debug circuit 16 includes a debug input/output port, and collects debug information (e.g. a value of a specific register or the like that indicates a status of the control system, or the like) of the aforementioned control system. The debug circuit 16 is installed as a function block in a semiconductor integrated circuit, and operates in synchronization with an operation clock. This semiconductor integrated circuit makes power separation among function blocks, and (a function block of) this debug circuit 16 is installed in a debug power supply layer 16a that is one of power supply layers separated for the function blocks.

The debug interface 17 is a physical port used for data communication with the debug circuit 16 and is connected to the debug input/output port.

The debug device 18 is an external device that acquires the debug information through the debug interface 17 from the debug circuit and performs analysis (e.g. determination of a trouble type or a trouble cause or the like) of the debug information.

The boot sequencer 19 performs a boot process of the control system using the processor 11.

The power supply circuit 20 individually turns on/off power supply of the power supply layers of the plural function blocks in the semiconductor integrated circuit. Thus, the power supply circuit 20 starts and cuts off power supply to the debug circuit 16. Here, the power supply circuit 20 performs starting and cutting off power supply to the debug interface 17 and the debug device 18 together with (in synchronization with) the starting and cutting off power supply to the debug circuit 16. Further, the clock circuit 21 turns on/off supply of the operation clock to the debug circuit 16.

When the CPU 11 or the boot sequencer 19 detects a debug request (a predetermined interrupt signal, a predetermined abnormal status or the like) as a predetermined event, the detecting CPU 11 or boot sequencer 19 tries collection of the debug information using the debug circuit 16.

Here, if the CPU 11 can operate when the debug request is detected, then the CPU 11 starts power supply and clock supply to the debug circuit 16 using the power supply circuit 20 and the clock circuit 21, and the debug circuit 16 performs collection of the debug information.

Contrarily, if the CPU 11 can not operate when the debug request is detected, then the boot sequencer 19 (a) reboots the control system after saving the debug information (from a register or the like) to the nonvolatile memory 14, (b) after the rebooting, starts power supply and clock supply to the debug circuit 16 using the power supply circuit 20 and the clock circuit 21 and restores the debug information (to the original register or the like); and after restoring the debug information, the debug circuit 16 performs collection of the debug information.

As mentioned, if the CPU 11 stalls and can not operate when the debug request occurs while the control system is in operation, then reboot of the CPU 11 (i.e. reboot of the control system) is performed.

Contrarily, in the initial boot (cold boot) performed when powering on or the like, the boot sequencer 19 changes statuses of the power supply and the clock supply to the debug circuit 16 to cutting-off statuses. Consequently, in a normal operation (i.e. until the debug request occurs), the power supply and the clock supply do not occur to the debug circuit 16 and therefore power consumption is small.

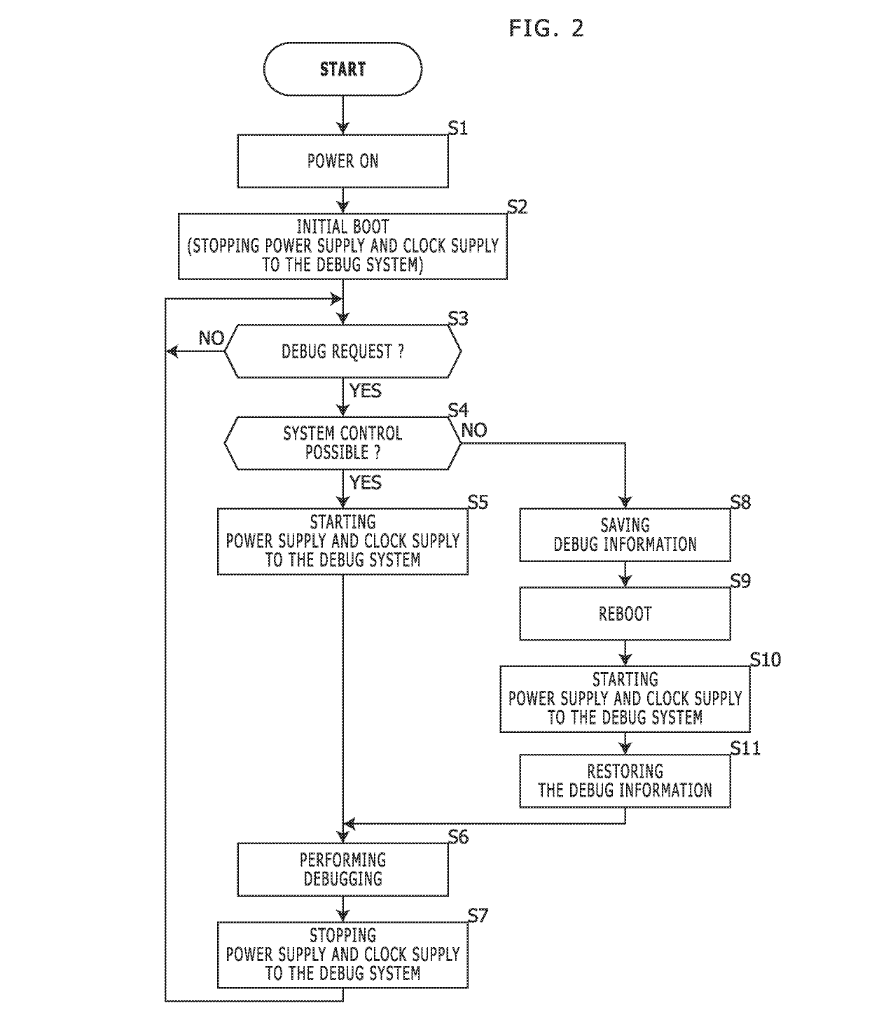

The following part explains the aforementioned electronic apparatus. FIG. 2 shows a flowchart that explains a behavior of the electronic apparatus shown in FIG. 1.

When this electronic apparatus is powered on (in Step S1), the boot sequencer 19 performs an initial boot of the control system, and causes the CPU 11 to execute a program of the control system while keeping stopping of power supply to the debug system (the debug circuit 16, the debug interface 17, and the debug device 18) and clock supply to the debug circuit 16 (in Step S2).

Afterward, when the debug request occurs and is detected while the control system is in a normal operation (in Step S3), if the CPU 11 can operate (in Step S4), then the CPU 11 (the control system) starts power supply to the debug system and clock supply to the debug circuit 16 using the power supply circuit 20 and the clock circuit 21 (in Step S5), and the debug system performs debugging (collection and analysis of the debug information, or the like) in accordance with a predetermined debug specification (in Step S6). Upon completion of the debugging, the CPU 11 (the control system) stops the power supply to the debug system and the clock supply to the debug circuit 16 using the power supply circuit 20 and the clock circuit 21 (in Step S7).

Contrarily, if the CPU 11 can not operate in Step S4 and the debug request occurs and is detected while the control system is in a normal operation, then the boot sequencer 19 detects that the CPU 11 is inoperable on the basis of an activity check based on a type of the debug request and/or communication with the CPU 11; and upon detecting that the CPU 11 is inoperable, the boot sequencer 19 firstly reads the debug information from the register or the like and writes the debug information into the nonvolatile memory 14 (in Step S8) and afterward performs reboot of the control system (in Step S9).

After the reboot of the control system, the boot sequencer 19 starts power supply to the debug system and clock supply to the debug circuit 16 using the power supply circuit 20 and the clock circuit 21 (in Step S10), and reads the debug information from the nonvolatile memory 14 and writes the debug information to the register or the like and thereby restores the debug information (in Step S11). After the restoration of the debug information, the debug system performs debugging in accordance with a predetermined debug specification (in Step S6). Further, upon completion of the debugging, the CPU 11 (the control system) stops the power supply to the debug system and the clock supply to the debug circuit 16 using the power supply circuit 20 and the clock circuit 21 (in Step S7).

As mentioned, in the aforementioned embodiment, the CPU 11 executes a program of a predetermined control system. Further, if the CPU 11 can operate when a debug request is detected, the CPU 11 starts power supply and clock supply to the debug circuit, and the debug circuit 16 performs collection of the debug information. Contrarily, if the CPU 11 can not operate when a debug request is detected, the boot sequencer 19 (a) reboots the control system after saving debug information to the nonvolatile memory 14, and (b) after rebooting, starts power supply and clock supply to the debug circuit and restores the debug information, and the debug circuit 16 performs collection of the debug information after restoring the debug information.

Consequently, since the debug information is saved even if the control system is rebooted, effective debugging can be performed even if the control system can not move the electronic apparatus to the debug mode.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An electronic apparatus, comprising:
a processor configured to execute a program of a predetermined control system;
a boot sequencer configured to perform a boot process of the control system using the processor;
a debug circuit configured to collect debug information of the control system; and
a nonvolatile memory;
wherein if the processor can operate when a debug request is detected, the processor starts power supply and clock supply to the debug circuit, and the debug circuit performs collection of the debug information; and
if the processor can not operate when a debug request is detected, the boot sequencer (a) reboots the control system after saving debug information to the nonvolatile memory, and (b) after rebooting, starts power supply and clock supply to the debug circuit and restores the debug information, and the debug circuit performs collection of the debug information after restoring the debug information.

2. The electronic apparatus according to claim 1, wherein the boot sequencer cuts off power supply and supplying a clock to the debug circuit in an initial boot.

3. The electronic apparatus according to claim 1, further comprising:
a power supply circuit configured to start and cut off power supply to the debug circuit;
a debug interface for communication with the debug circuit; and
a debug device configured to acquire the debug information through the debug interface;
wherein the power supply circuit not only starts and cuts off power supply to the debug circuit but starts and cuts off power supply to the debug interface and the debug device.
